(19) United States
(12) Patent Application Publication
(10) Pub. No.: US 2025/0181414 A1
(43) Pub. Date: Jun. 5, 2025

(54) METHOD FOR MAPPING API FUNCTIONS TO THREAT ACTIONS IN MULTIPLE CLOUD ENVIRONMENTS

(71) Applicant: ASTRON SECURITY INC., Seoul (KR)

(72) Inventors: Keun Seok CHO, Gyeonggi-do (KR); Dong Ik KWAK, Gyeonggi-do (KR)

(73) Assignee: ASTRON SECURITY INC., Seoul (KR)

(21) Appl. No.: 18/534,828

(22) Filed: Dec. 11, 2023

(30) Foreign Application Priority Data
Dec. 5, 2023 (KR) 10-2023-0174843

(51) Int. Cl. G06F 9/50; G06F 9/54

(52) U.S. Cl. CPC G06F 9/5072; G06F 9/541

(57) ABSTRACT

A method for mapping API functions to threat actions by a server in multiple cloud environments includes the steps of a) mapping a first API function used in a first cloud environment provided by a first cloud server to a first threat action included in an attack technique database where a plurality of threats classified into multiple types is stored, b) generating feature information of the first API function based on descriptive information for the first API function provided by the first cloud server, c) based on the feature information of the first API function, identifying a second API function matching the first API function among at least one API function used in a second cloud environment provided by a second cloud server, and d) mapping the second API function to the first threat action.

### CROSS-REFERENCE TO RELATED APPLICATIONS

This application claims priority to and the benefit of Korean Patent Application No. 10-2023-0174843, filed on Dec. 5, 2023, which is incorporated herein by reference in its entirety.

### FIELD

The present disclosure relates to a method for mapping API functions to threat actions in multiple cloud environments, and more specifically, to a technology for providing a framework to enhance the security of cloud services and identify and address security threats that may arise in various cloud environments.

### BACKGROUND

The statement in this section merely provide background information related to the present disclosure and may not constitute prior art.

With the recent advancements in cloud computing technology, there is an increasing trend among businesses and individuals to use various cloud services. These services interact through their unique APIs, which can pose security vulnerabilities. However, existing security solutions primarily focus on a single cloud environment, limiting their effectiveness in identifying and addressing threats related to interactions across diverse cloud environments. Consequently, there is a growing demand for methods to map API functions to threat actions in multiple cloud environments. Document Korean Patent Application Publication No. 10-2015-0008158 relates to systems and methods for identifying, deterring and/or delaying attacks to a network using shadow networking technique.

The above information discloses in this Background section is only for enhancement of understanding of the background of the present disclosure, and therefore it may contain information that does not form the prior art that is already known to a person of ordinary skill in the art.

### SUMMARY

The present disclosure provides a method for effectively identifying and addressing security threats occurring in various cloud environments. The present disclosure also provides a method for improving the efficiency of security management by accurately mapping API functions of cloud services to threat actions.

In one aspect of the present disclosure, there is provided a method for mapping API functions to threat actions by a server in multiple cloud environments, the method including: a) mapping a first API function used in a first cloud environment provided by a first cloud server to a first threat action included in an attack technique database where a plurality of threats classified into multiple types is stored; b) generating feature information of the first API function based on descriptive information for the first API function provided by the first cloud server; c) based on the feature information of the first API function, identifying a second API function matching the first API function among at least one API function used in a second cloud environment provided by a second cloud server; and d) mapping the second API function to the first threat action.

In one embodiment of the present disclosure, step b) may include: transmitting a first request prompt to a generative artificial intelligence server, asking for summary information of a first API which encapsulates the descriptive information for the first API function; receiving the summary information of the first API from the generative artificial intelligence server in response to the first request prompt; and generating the feature information of the first API based on the summary information of the first API.

In one embodiment of the present disclosure, step b) may further include identifying a service performed in the first cloud environment when the first API function is executed, and the feature information may also be based on information on the service.

In one embodiment of the present disclosure, step c) may include: generating feature information of the second API function based on descriptive information for the second API function provided by the second cloud server; requesting similarity information between the feature information of the first API function and the feature information of the second API function from the generative artificial intelligence server, and receiving the similarity information from the generative artificial intelligence server; based on the similarity information, determining the first API function and the second API function as similar API functions; and identifying the second API function as an API function matching the first API function.

In one embodiment of the present disclosure, the generative artificial intelligence server may be provided as a plurality of generative artificial intelligence servers, and the similarity information may include a plurality of pieces of similarity information generated from the plurality of generative artificial intelligence servers, and in determining as the similar API functions, the server may compares the plurality of pieces of similarity information to determine whether the first API function and the second API function are similar.

In one embodiment of the present disclosure, each of the plurality of pieces of similarity information may be assigned a predetermined weight based on a corresponding generative artificial intelligence server.

In one embodiment of the present disclosure, the generating of the feature information of the first and second API functions may include: transmitting first and second request prompts to the generative artificial intelligence server, asking for summary information of first and second APIs, which encapsulates the descriptive information for the first and second API functions; receiving the summary information of the first and second APIs in response to the first and second request prompts from the generative artificial intelligence server; and based on the summary information of the first and second APIs, generating feature information of the first and second API functions.

In one embodiment of the present disclosure, the first and second request prompts may include a request to generate the summary information for the first and second APIs based on same content items.

In one embodiment of the present disclosure, the identifying of the second API function may further include identifying a terminology database in which terms used in the first and second cloud environments are matched, and in receiving the similarity information, the server may provide the generative artificial intelligence server with information on the terminology database and requests generation of the similarity information based on the terminology database.

In one embodiment of the present disclosure, the method may further include: verifying occurrence of the first threat action based on a user's event information of the second API function in the second cloud environment; verifying a response scenario for a threat scenario containing the first threat action in the first cloud environment; and based on the response scenario, determining a response solution in the second cloud environment.

In one embodiment of the present disclosure, the determining of the response solution may include: verifying a first response API function used in the first cloud environment and included in the response scenario; and verifying a second response API function corresponding to the first response API function among the at least one API function used in the second cloud environment.

In one embodiment of the present disclosure, the following steps may be performed between step (c) and step (d): verifying information where the second API function is mapped to a second threat action included in the attack technique database, wherein the first and second threat actions are different from each other; and comparing mapping accuracy between first mapping information, where the first API function and the first threat action are mapped to each other, and second mapping information, where the second API function and the second threat action are mapped to each other. When a mapping accuracy of the first mapping information is higher than a mapping accuracy of the second mapping information, step d) may be performed, and when the mapping accuracy of the second mapping information is higher than the mapping accuracy of the first mapping information, step d) may not be performed and instead the first API function may be mapped to the second threat action.

In one embodiment of the present disclosure, the first mapping information may include a plurality of pieces of mapping index information for the first API function and the first threat action, received from a plurality of generative artificial intelligence servers, the second mapping information may include a plurality of pieces of mapping index information for the second API function and the second threat action, received from a plurality of generative artificial intelligence servers, and the server may compare the mapping accuracy based on outlier information of the plurality of pieces of mapping index information included in each of the first and second mapping information.

The attack technique database may include information on types of attack techniques, descriptive information for the attack techniques, and information on sub-techniques included in the attack techniques. The type may be a higher-level concept comprising at least one of the attack techniques, and each of the attack techniques may be a higher-level concept comprising at least one of the sub-techniques.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a diagram illustrating an example of a network environment according to an embodiment of the present disclosure;

FIG. 2 is a diagram illustrating an example of a process of mapping API functions to threat actions in multiple cloud environments according to an embodiment of the present disclosure;

FIG. 3 is a diagram illustrating part of the MITER ATT&CK cloud matrix, which is an attack technique database, according to an embodiment of the present disclosure;

FIG. 4 is a flowchart illustrating a method for mapping API functions to threat actions in multiple cloud environments according to an embodiment of the present disclosure;

FIG. 5 shows an example of a method for mapping API functions to threat actions in multiple cloud environments according to an embodiment of the present disclosure;

FIG. 6 is a table illustrating a method for identifying a matching API function based on feature information of the API function according to an embodiment of the present disclosure.

FIG. 7 is a flowchart illustrating a method for comparing mapping accuracy between mapping information where API functions are mapped to threat actions, according to an embodiment of the present disclosure;

FIG. 8 is a table for explaining a method for comparing mapping accuracy between a plurality of pieces of mapping index information according to an embodiment of the present disclosure;

FIG. 9 is a flowchart illustrating a method for determining a response solution based on a response scenario for a threat scenario containing a threat action according to an embodiment of the present disclosure; and

FIG. 10 is a diagram illustrating an example of a process of determining a response solution based on a response scenario for a threat scenario containing a threat action according to an embodiment of the present disclosure.

The drawings described herein are for illustration purposes only and are not intended to limit the scope of the present disclosure in any way.

### DETAILED DESCRIPTION

Hereinafter, embodiments disclosed in the present specification will be described in detail with reference to the attached drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, the present disclosure will be described with reference to the attached drawings.

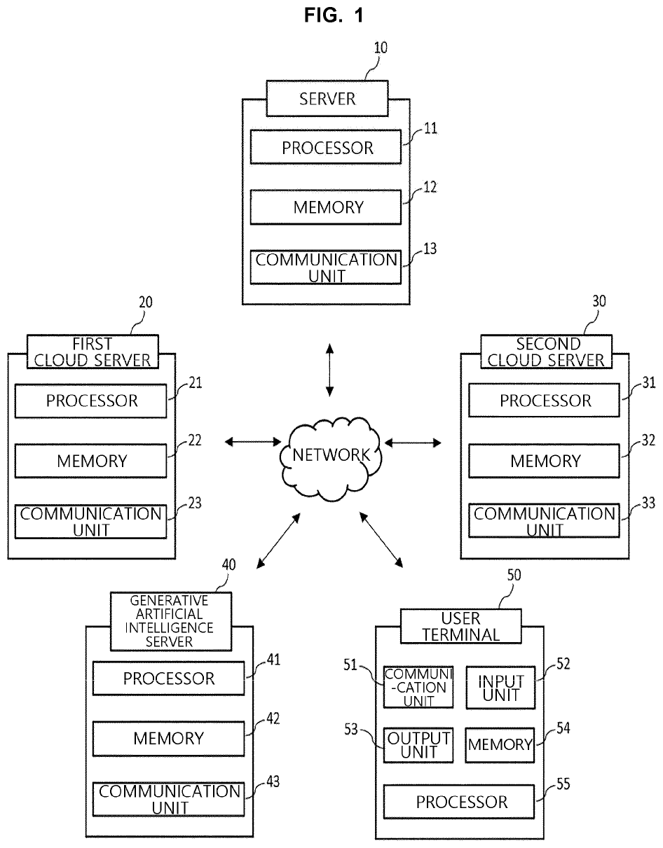

FIG. 1 is a diagram illustrating an example of a network environment according to an embodiment of the present disclosure.

A network environment according to an embodiment of the present disclosure shown in FIG. 1 may include a server 10, a first cloud server 20, a second cloud server 30, a generative artificial intelligence server 40, and a user terminal 50.

The server 10 is a device that analyzes API functions of multiple cloud environments, including the first cloud server 20 and the second cloud server 30, and provides a user with an API function mapping service of mapping API mapping functions to threat actions stored in an attack technique database.

The server 10 according to various embodiments of the present disclosure may be implemented as a computer device or a plurality of computer devices to provide commands, codes, files, content, services, etc. The server 10 according to one embodiment of the present disclosure may be a single electronic device capable of transmitting and receiving information by communicating with the first cloud server 20, the second cloud server 30, the generative artificial intelligence server 40, and the user terminal 50 over a network. Although the server 10 has been described as a single server for convenience of explanation, the server 10 may be provided as a plurality of servers and each server may provide different functions or services.

The server 10 may include a processor 11, a memory 12, and a communication unit 13. The processor 11 may control the overall operation of the memory 12 and the communication unit 13. According to various embodiments of the present disclosure, the memory 12 may serve as a storage medium and store a number of application programs running on the server 10, and data and instructions for operating the server 10. In one embodiment, the memory 12 may be provided in the form of any of various hardware storage devices such as a read only memory (ROM), a random access memory (RAM), a flash drive, hard drive, etc., or may be provided in the form of a web storage. The communication unit 13 may communicate with the user terminal 50 over a network in a wired or wireless manner.

The processor 11 may control the overall operation of the memory 12 and the communication unit 13 and provide the user terminal 50 with an API function mapping service.

The memory 12 may serve as a storage medium and store a number of application programs running on the server 10, and data and commands for operation of the server 10. In one embodiment, an application associated with the API function mapping service may be stored in the memory 12. The memory 12 may be provided in the form of any of various hardware storage devices such as a read only memory (ROM), a random access memory (RAM), a flash drive, hard drive, etc., or may be provided in the form of a web storage.

The communication unit 13 may communicate with the user terminal 50 over a network in a wired or wireless manner.

The server 10 of the present disclosure performs a method for mapping API functions to threat actions in multiple cloud environments. Specifically, the server 10 may map a first API function used in a first cloud environment provided by a first cloud server to a first threat action included in the attack technique database, generate feature information of the first API function based on descriptive information for the first API function provided by the first cloud server, identify, based on the feature information of the first API function, a second API function matching the first API function among at least one API function used in a second cloud environment provided by a second cloud server, and map the second API function to the first threat action.

In addition, the server 10 may transmit a first request prompt to the generative artificial intelligence server, asking for summary information of a first API which encapsulates the descriptive information for the first API functions, receive the summary information of the first API from the generative artificial intelligence server in response to the first request prompt, and generate feature information of the first API based on the summary information of the first API function.

Additionally, the server 10 may identify a service that is performed in the first cloud environment when the first API function is executed.

Here, multiple cloud environments refer to different cloud platforms or infrastructure provided by various cloud service providers. Specifically, the multiple cloud environments each provide unique APIs, which may have different functions and security characteristics. The multiple cloud environments may be various cloud services, such as Amazon Web Services (AWS), Google Cloud Platform (GCP), and Microsoft Azure, for example.

Here, the API functions are interfaces required to use a cloud service and include commands, protocols, and tools that enable interactions between users or other applications and the cloud service. Specifically, the API functions may be used to access various cloud-based services and resources, exchange data, and perform complex tasks. For example, storage management, computing resource allocation, and database query execution are accomplished through the API functions. Each cloud service provider offers a unique set of APIs designed to integrate with a platform thereof, and these APIs may be used for a variety of aspects, including security, performance, and ease of use.

Here, the attack technique database is based on the MITER ATT&CK framework. Specifically, the Adversarial Tactics, Techniques, and Common Knowledge (ATT&CK) framework may be a knowledge-based system that includes widely used strategies, tactics, techniques, and procedures in cybersecurity. The attack technique database systematically classifies and organizes various attack methods used in actual cyber threat scenarios, and provides detailed description, examples of use, and defense strategies for each attack method. As a result, the server 10 may more accurately identify potential security threats occurring in a cloud environment and effectively map vulnerabilities related to API functions. The ATT&CK framework is continuously updated and may reflect the latest cyber-attack techniques and response strategies.

In addition, the attack technique database may include information on the type of an attack technique, descriptive information for the attack technique, and information on sub-techniques included in the attack technique. Here, a type may be a higher-level concept including at least one of the above-described attack techniques, and an attack technique may be a higher-level concept including at least one of the sub-techniques.

Here, a threat action corresponds to an attack technique in the attack technique database. Specifically, threat actions may refer to ‘Techniques’ of the Adversarial Tactics, Techniques, and Common Knowledge (MITER ATT&CK) framework, which is the attack technique database.

Here, mapping refers to a process of matching API functions of cloud environments to cyber security threat actions.

Here, descriptive information refers to detailed documentation or guides on API functions provided by various cloud service providers. Specifically, the descriptive information may include specific descriptions, usage methods, implementation details, parameters, return values, and the like of API functions. For example, the descriptive information may be Amazon's Document DB or Microsoft's Azure Cosmos DB.

Here, feature information is data that summarizes the key properties and behavior patterns of each API function. The feature information may include functional characteristics, usage method, input and output format, execution environment, security elements, etc. of each API.

Here, matching refers to a process of establishing a correspondence between API functions used in one cloud environment and API functions used in another cloud environment. For example, matching may be a process of matching a specific database management function provided by Amazon's Document DB with a similar function provided by Azure Cosmos DB.

Here, a request prompt refers to a specific information request command that the server 10 sends to the generative artificial intelligence server 40. For example, the server 10 requests the generative AI server 40 to summarize the description of an API function related to Amazon's Document DB or generate feature information of a specific function. A command or directive used for this purpose is referred to as a request prompt.

The first cloud server 20 may provide the server 10 and the user terminal 50 with various API functions and descriptive information therefor through the infrastructure and services of a specific cloud service provider. Additionally, the API functions of the first cloud server 20 may be used to enable various cloud services such as data management, resource allocation, and service management.

The first cloud server 20 may include a processor 21, a memory 22, and a communication unit 23. Each element included in the first cloud server 20 performs substantially the same function as each element included in the server 10. A detailed description of each element of the first cloud server 20 will be omitted in favor of the description provided for the server 10.

The second cloud server 30 may provide different API functions and descriptive information compared to the first cloud server 20, through infrastructure and services of a cloud service provider different from that of the first cloud server 20. The second cloud server 30 may include a processor 31, memory 32, and communication unit 33. Each element included in the second cloud server 30 performs substantially the same function as a corresponding element included in the first cloud server 20. A detailed description of each element of the second cloud server 30 will be omitted in favor of the description provided for the first cloud server 20.

The generative artificial intelligence server 40 is an advanced computing system used to process and analyze complex data. That is, the generative artificial intelligence server 40 may utilize artificial intelligence, particularly machine learning and natural language processing (NLP) technologies, to analyze and process various data related to API functions.

The generative artificial intelligence server 40 may include a processor 41, a memory 42, and a communication unit 43. Each element included in the generative artificial intelligence server 40 performs substantially the same function as a corresponding element included in the server 10. A detailed description of each element of the generative artificial intelligence server 40 will be omitted in favor of the description provided for the server 10.

The user terminal 50 is a device that uses an API function mapping service provided by the server 10 and is used by a user to access and interact with multiple cloud environments.

The user terminal 50 may include a communication unit 51, an input unit 52, an output unit 53, a memory 54, and a processor 55.

The communication unit 51 may communicate with the server 10 or other terminals in a wired or wireless manner.

The input unit 52 may receive various types of information by the user's operation and input action. Such an input unit may include a touch screen module, a keyboard, a mouse, a button, a camera, a stylus, a microphone, etc.

The user terminal 50 may receive a user's interaction through the input unit 52. An interaction refers to a user's operating the input unit 52 to input information reflecting the user's selection or intention into the user terminal 50. For example, the interaction may include touching on a touchscreen, clicking with a mouse, typing on a keyboard, providing voice input through a microphone, capturing an image using a camera, recognizing a movement through a motion sensor, and the like.

The output unit 53 may output various types of information. The output unit 53 may be a display device, a speaker, a vibration generator, a tactile generator, etc. In some cases, the output unit 53 may be a device (e.g., Bluetooth earphone) that is connected to the user terminal 50 through wired or wireless communication (e.g., short-range radio communication such as Bluetooth) to receive and output a signal.

The memory 54 serves as a storage medium and may store a plurality of application programs running on the user terminal 50, and data and instructions for operating the first user terminal 50. Such a memory may be provided in the form of any of various hardware storage devices such as an ROM, an RAM, a flash drive, a hard drive, etc. or may be provided in the form of web storage. In one embodiment, an application (hereinafter, referred to as “application”) related to an API function mapping service may be stored in the memory 54.

The processor 55 may execute an application by controlling the overall operation of the communication unit 51, input unit 52, output unit 53, and memory 54.

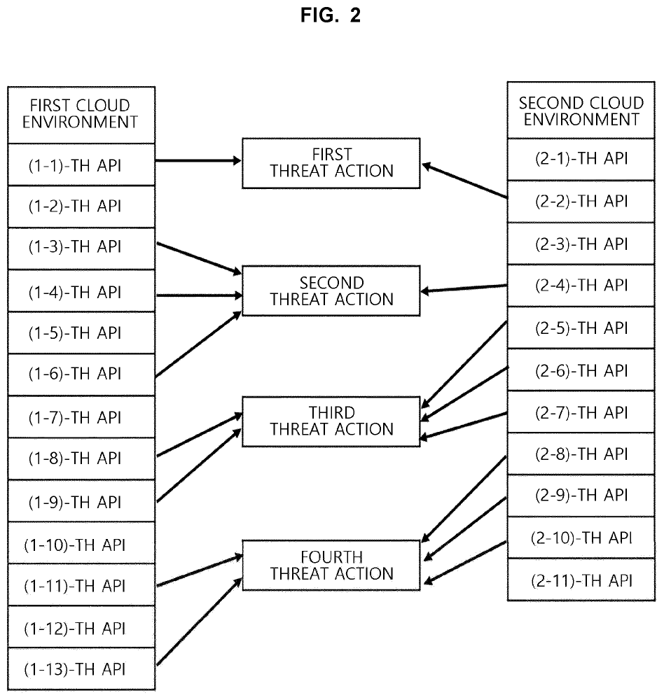

FIG. 2 is a diagram illustrating an example of a process of mapping API functions to threat actions in multiple cloud environments according to an embodiment of the present disclosure.

Referring to FIG. 2, mapping of threat actions in a first cloud environment and threat actions in a second cloud environment is illustrated. The first cloud environment includes a (1-1)-th API to a (1-13)-th AIP, among which a (1-2)-th API, a (1-7)-th API, a (1-10)-th API, and a (1-12)-th API are not mapped to any threat actions. Any unmapped API may not have vulnerabilities identified within the current scope of analyzed threat actions or may not have been analyzed yet by the server 10.

The number of APIs may vary based on a cloud environment, and multiple API functions may be mapped to one threat action.

Although not shown in the drawing, it is also possible for one API function to be mapped to multiple threat actions. For example, for the same API function, different threat actions may be mapped based on services used within cloud environments.

Referring to FIG. 2, it can be seen that both a (1-1)-th API of the first cloud environment and a (2-2)-th API of the second cloud environment are mapped to a first threat action.

To this end, it is possible to generate a mapping result as shown in FIG. 1, by mapping the (1-1)-th API to the first threat action and the (2-2)-th API to the first threat action.

However, in some cases, the (1-1)-th API and the first threat action are mapped first, and while the (2-2)-th API and the first threat action are not yet mapped, the (1-1)-th API and the (2-2)-th API are matched as similar APIs so that the (2-2)-th API can be mapped to the first threat action. Consequently, matching between the (1-1)-th API and the (2-2)-th API is performed instead of analyzing and mapping the content of the (2-2)-th API and the first threat action. Mapping an API to a threat action is comparing a function and an action, whereas matching one API to another API is comparing functions. Thus, matching one API to another API may be comparatively easier or more accurate. Therefore, this method has the advantage of more easily and accurately mapping APIs and threat actions in multiple cloud environments.

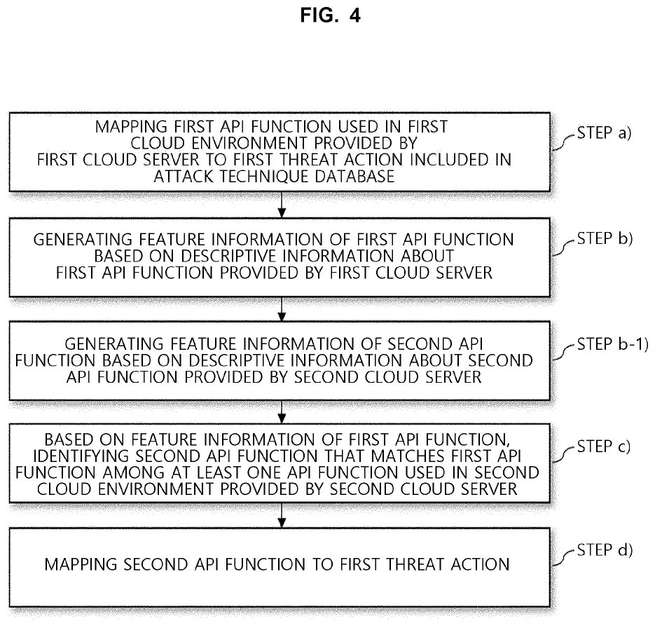

Details of the above-described method will be described in detail with reference to FIGS. 4 to 10.

Additionally, referring to FIG. 2, a third threat action is mapped to a (1-8)-th API and (1-9)-th API of the first cloud environment and a (2-5)-th API, (2-6)-th API, and (2-7)-th API of the first cloud environment. Since the (2-5)-th API, the (2-6)-th API, and the (2-7)-th API are matched with the (1-8)-th API based on feature information of each API, the server 10 may map the (2-5)-th API, the (2-6)-th API, and the (2-7)-th API to the third threat action. However, if the (1-9)-th API and the (2-7)-th API are determined to be dissimilar according to a result of similarity assessment, the server 10 may not map the (2-7)-th API to the third threat action.

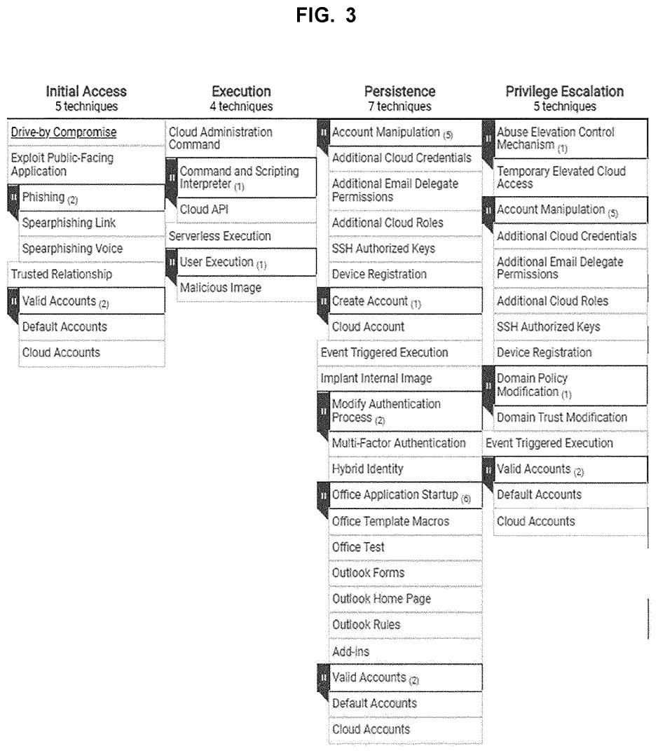

FIG. 3 is a diagram illustrating part of the MITER ATT&CK cloud matrix, which is an attack technique database, according to an embodiment of the present disclosure.

Referring to FIG. 3, part of the cloud matrix of the ATT&CK framework of MITER ATT&CK, which is an attack technique database, is shown.

Referring to FIG. 3, as information on the types of attack techniques in the attack technique database, ‘Initial Access’, ‘Execution’, ‘Persistence’, and ‘Privilege Escalation’ corresponding to tactics are shown. Each tactic includes 5, 4, 7, and 5 techniques, which are referred to as attack techniques and threat actions in the present disclosure. Specifically, the tactic ‘Initial Access’ includes techniques of ‘Drive-by Compromise’, ‘Exploit Public-Facing Application’, ‘Phishing’, ‘Trusted Relationship’, and ‘Valid Accounts’. Also, ‘Phishing’ and ‘Valid Accounts’ further include sub-techniques corresponding to sub-techniques.

FIG. 4 is a flowchart illustrating a method for mapping API functions to threat actions in multiple cloud environments according to an embodiment of the present disclosure.

At step a), a server 10 maps a first API function used in a first cloud environment provided by a first cloud server 20 to a first threat action included in an attack technique database.

The server 10 may analyze the data and characteristics of the API function collected from the first cloud server 20 to identify whether the response API function could be exposed to a security threat corresponding to a threat action of the attack technique database. Here, the attack technique database may include multiple threat actions classified into multiple types.

The server 10 may either map an API function to a plurality of threat actions or not map the API function to any threat action, depending on the API function. For example, if the plurality of threat actions correspond to the API function, it is possible to calculate a degree of correspondence and severity between each threat action and the API function, derive a weighted score for each threat action, and calculate a weighted aggregate score. A threat action with an aggregate score higher than or equal to a predetermined reference score may be mapped, and a threat action with an aggregate score less than the predetermined reference score may not be mapped.

At step b), the server 10 generates feature information of the first API function based on descriptive information for the first API function provided by the first cloud server 20.

When the first API function is executed, the server 10 may identify a service performed in the first cloud environment and incorporate information on the service into the feature information. Here, the service refers to a specific function or task provided in a cloud environment. Specifically, the service may include a cloud-based application, a data management system, a computing resource, a network function, etc. For example, when the first API function is used in a cloud-based database management service, the first API function may perform tasks such as data querying, updating, or deletion. Here, the server 10 may categorize and generate feature information detailing the API function's role in database management and the API function's interactions with different data types.

The server 10 may transmit a request prompt to the generative artificial intelligence server 40, asking for summary information of the API function which encapsulates the descriptive information for the API function. Then, the server 10 may receive the summary information of the API from the generative artificial intelligence server 40 in response to the request prompt and generate feature information of the API function based on the summary information. Here, the summary information’ may concisely include the basic operating principles, usage methods, security characteristics, etc. of the API. For example, concerning a specific API function of the first cloud server 20, the server 10 may transmit a request prompt stating ‘Please summarize the key functions and security aspects of this API.’ In response to this request, the generative artificial intelligence server 40 may provide information that briefly summarizes the key characteristics, usage scenarios, and potential security vulnerabilities of the corresponding API function. For example, server 10 may set the same content items for descriptive information for first and second API functions for the purpose of comparison when the descriptive information for the first and second API functions are provided in different formats, such as Amazon's Document DB and Azure Cosmos DB. Specifically, the same content items may be categories that encompass key information of each API, such as a corresponding API's main functions, usage methods, security characteristics, etc.

Through the request prompt, the server 10 may request the generative artificial intelligence server 40 to generate summary information of the first and second APIs based on the same content items.

At step b-1), the server 10 generates feature information of the second API function based on descriptive information for the second API function provided by a second cloud server 30.

How to generate feature information At step b-1) is substantially the same as that of step b) described above. A detailed description thereof will be omitted.

A point in time at which the server 10 generates the feature information of the second API function may be before a point in time at which the server 10 generates the feature information of the first API. Alternatively, the point in time at which the server 10 generates the feature information of the second API function may be a point in time to identify the second API function that matches the first API function. For example, before generating the feature information of the first API, the server 10 may have generated feature information of every API used in the second cloud environment provided by the second cloud server and store the generated feature information in a database.

At step c), based on the feature information of the first API function, server 10 identifies the second API function that matches the first API function among at least one API function used in the second cloud environment provided by the second cloud server 30.

The server 10 may identify the second API function that is similar or associated with the first API function among API functions used in the second cloud environment provided by the second cloud server 30. For example, if the API of the first cloud environment provides a function associated with data analysis, the server 10 may find an API that provides a similar data analysis function in the second cloud environment. Specifically, the server 10 may identify the API by comparing and analyzing API functions, data processing methods, and security requirements.

Alternatively, the server 10 may identify the second API function similar to or associated with the first API function based on feature information of API functions used in the second cloud environment provided by the second cloud server 30. For example, when the feature information of the first API function includes category information corresponding to a cloud-based database management service, an API function including category information corresponding to a cloud-based database management service among feature information of API functions used in the second cloud environment may be identified as the second API function.

Here, the feature information of the first and second APIs may be configured in the same or similar content items. In a process of comparing the first and second APIs, the server 10 may determine as to the similarity between the first and second APIs by comparing the corresponding content items.

The server 10 may request similarity information between the feature information of the first API function and the feature information of the second API from the generative artificial intelligence server 40. Then, based on the similarity information received from the generative artificial intelligence server 40, the server 10 may identify the second API function as an API function matching the first API function. Here, the similarity information is data indicating the similarity between the first API function and the second API function. For example, the similarity information may include the results of comparative analysis of the features, functions, operating principles, security requirements, etc. of the two API functions.

The server 10 may generate a plurality of pieces of similarity information by requesting the similarity information from a plurality of generative artificial intelligence servers, and determine whether the first API function and the second API function are similar by comparing the plurality of pieces of similarity information. For example, each score may be calculated based on similarity information received from the plurality of generative artificial intelligence servers, and an average of the calculated scores may be used to determine whether the first API function and the second API function are similar.

Additionally, each of the plurality of pieces of similarity information may be assigned a predetermined weight based on a corresponding generative artificial intelligence server. For example, when the first artificial intelligence server holds a weight of 0.5 and a resulting similarity score is 10 points, an aggregated similarity score, considering the weighting, may be calculated as 5.

At step d), the server 10 maps the second API function to the first threat action.

The server 10 may analyze the feature information of the second API function and the first threat action in the attack technique database to determine which security vulnerabilities or risk factors could be associated with the response API function.

Here, the second API function may be mapped to the first threat action for the first time through step d), without having been mapped to any other threat action. However, in some cases, the mapping of the second API function which has been mapped to a specific threat action (for example, the second threat action) may be altered in step d), resulting in a switch from the specific threat action to the first threat action.

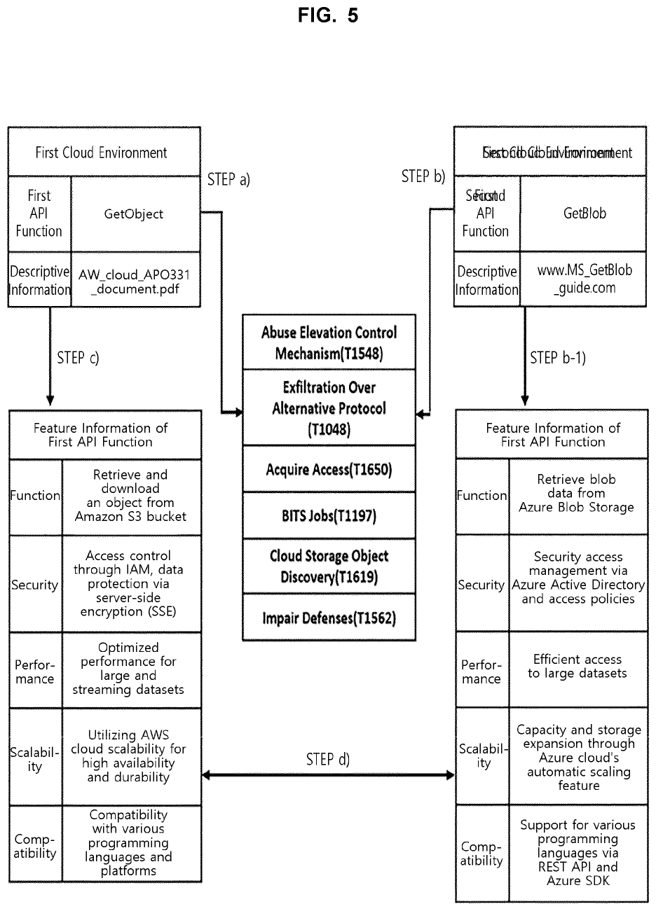

FIG. 5 is a diagram for explaining an example in which steps a) to d) of FIG. 4 described above are performed.

Referring to FIG. 5, the server 10 may map ‘GetObject’ of Amazon S3, which is the first API function in the first cloud environment, to ‘Exfiltration Over Alternative Protocol (T1048)’, which is a threat action included in the attack technique database (step a)).

Referring to FIG. 5, ‘AW_cloud_API331_document.pdf’ provided by the first cloud environment is shown as descriptive information for the first API function ‘GetObject.’ The descriptive information may be provided from a cloud environment in any of various forms, depending on the purpose and nature of the information. For example, the descriptive information for the second cloud environment may be provided in the form of a link as shown in FIG. 5. The server 10 may generate feature information of ‘GetObject’, which is the first API function, based on the descriptive information. The feature information of the first API function may be generated in separate categories such as function, security, performance, scalability, and compatibility (step b).

Referring to FIG. 5, the server 10 may determine similarity and relevance between the first API function and the second API function based on the feature information of the first API function and the feature information of the second API function, and perform matching on the first API function and the second API function (step c)).

Referring to FIG. 5, the server 10 may map the second API function to the same threat action as the one matched with the first API function, based on to a result of matching the first API function and the second API function (step d)).

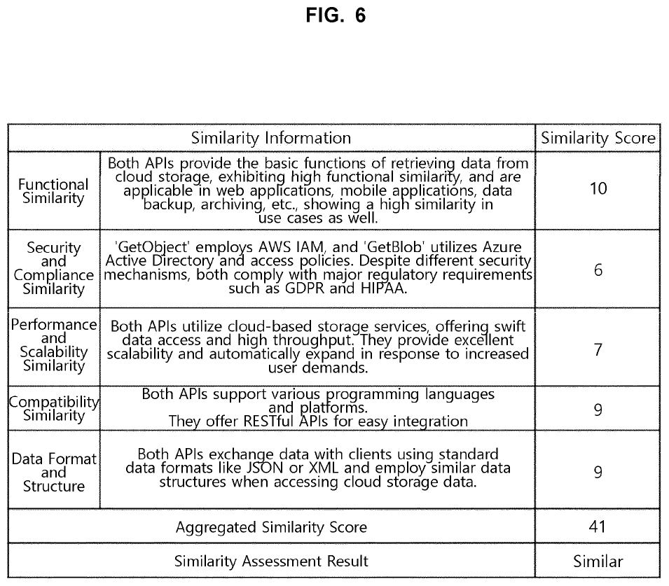

FIG. 6 is a table illustrating a method for identifying a matching API function based on feature information of the API function according to an embodiment of the present disclosure. FIG. 6 is a diagram for explaining an example in which step c) of FIG. 4 is performed.

Referring to FIG. 6, there is illustrated an example in which similarity between the first API function and the second API function is determined based on the feature information of the first API function and the second API function of FIG. 5, and similarity between the first API function and the second API function is determined by calculating a similarity score therebetween.

Referring to FIG. 6, the first API function and the second API function may provide the basic function of retrieving data from a cloud storage and may be used in web applications, mobile applications, data backup and archive, etc. Thus, a functional similarity score thereof is calculated as 10.

Referring to FIG. 6, the first API function and the second API function have 10 points in functional similarity, 6 points in security and compliance similarity, 7 points in performance and scalability similarity, 9 points in compatibility similarity, and 9 points data format and structure. The aggregated similarity score of 41 points leads to a determination of ‘similar’ in the similarity assessment result.

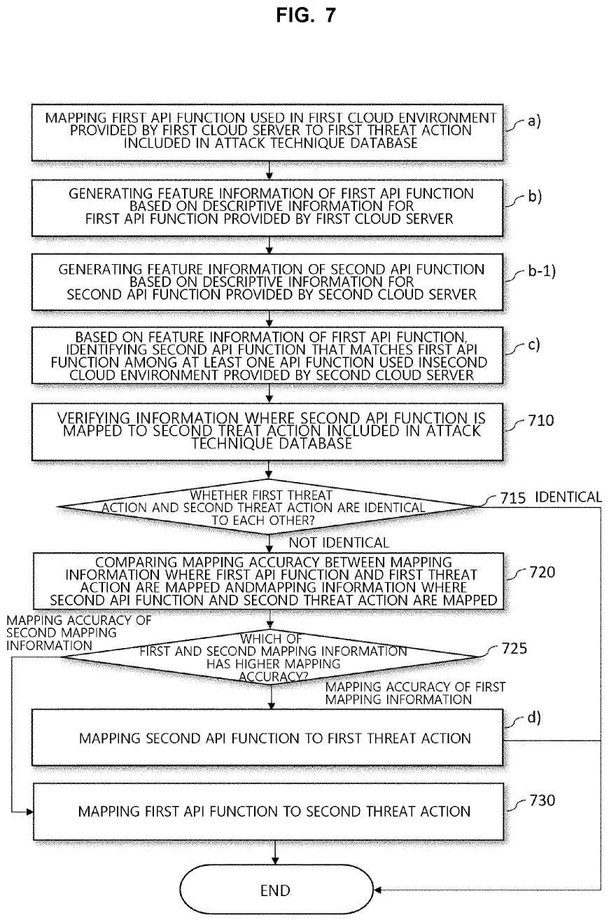

FIG. 7 is a flowchart illustrating a method for comparing mapping accuracy between mapping information where API functions are mapped to threat actions, according to an embodiment of the present disclosure.

The embodiment of FIG. 7 relates to a state in which a second threat action has been mapped to a second API function.

Step a), step b), step b-1, step c), and step d) of FIG. 7 are substantially the same as the steps of FIG. 4. A detailed description thereof will be omitted in favor of the description provided with reference to FIG. 4.

At step 710, the server 10 verifies information where the second API function is mapped to the second threat action included in the attack technique database. The sequence of step 710 is not limited to what is shown in FIG. 7. For example, step 710 may also be performed before step a).

The server 10 may verify information on how the second API function is mapped to the second threat action included in the attack technique database. For example, if the second API function provides a function related to user authentication, the server 10 may analyze how the second API function maps to authentication bypass, credential stuffing, or other authentication-related attack techniques. Additionally, through this analysis, the server 10 may determine how vulnerable the second API function is to a specific security threat or what security measures are required to address the corresponding threat.

At step 715, the server 10 determines whether a first threat action and the second threat action are identical to each other.

The server 10 may determine whether the previously identified first and second threat actions are identical to each other. If the first and second threat actions are determined to be identical, the server 10 may verify that the first API function and the second API function share similar security vulnerabilities in the respective cloud environments.

If the first threat action and the second threat action are not determined to be identical, the server 10 may perform step 720.

At step 720, the server 10 compares mapping accuracy between first mapping information, where the first API function and the first threat action are mapped, and second mapping information, where the second API function and the second threat action are mapped. Here, the mapping accuracy is a measure of how accurately the association between the API function and the threat action is identified to map the API function and the threat action.

Specifically, the mapping accuracy may rely on association (how closely a mapped threat action is associated with the actual operation and security aspects of an API function), suitability to a threat scenario (the extent to which a threat action mapped to a specific API function aligns with the usage scenarios of a corresponding API), and alignment with the attack technique database (the correspondence between characteristics of a threat action recorded in the attack technique database and an API function mapped thereto).

The server 10 may analyze the association between the first API function and the first threat action in the first mapping information. Specifically, the features, security vulnerabilities, and susceptibility to attacks, etc. of the corresponding API function may be considered. At the same time, the server 10 may equally analyze the association between the second API function and the second threat action in the second mapping information.

At step 725, the server 10 determines which of the first and second mapping information has the higher mapping accuracy.

The server 10 may prioritize mapping information with a higher mapping accuracy among the first mapping information and the second mapping information. At step 730, server 10 maps the first API function to the second threat action.

When the mapping accuracy of the first mapping information is higher, the server 10 may perform step d) to map the second API function to the first threat action. Alternatively, when the mapping accuracy of the second mapping information is higher, the server 10 may map the first API function to the second threat action.

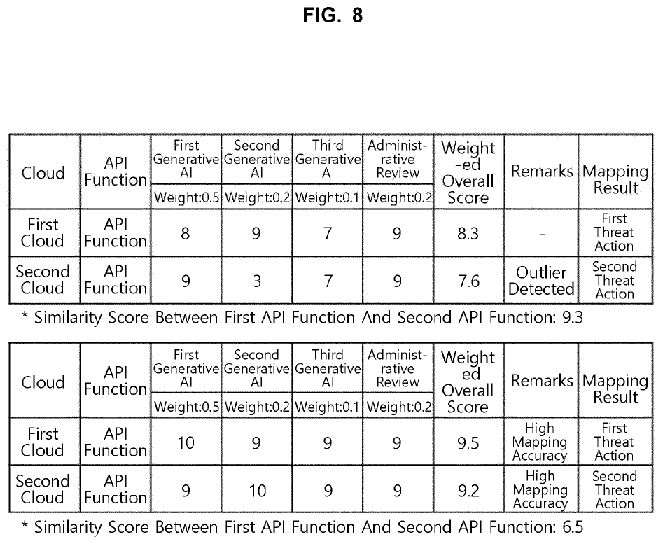

FIG. 8 is a table for explaining a method for comparing mapping accuracy between a plurality of pieces of mapping index information according to an embodiment of the present disclosure.

Referring to FIG. 8, the server 10 may receive mapping accuracy scores between threat actions and API functions corresponding to multiple generative AI servers (a first generative AI server, a second generative AI server, and a third generative AI server) and administrative review. The mapping accuracy score may be calculated based on predetermined weights corresponding to the multiple generated AI servers and the administrative review.

Referring to FIG. 8, in the first table, a mapping accuracy score between the first API function and the first threat action is calculated as 8.3 points, and a mapping accuracy score between the second API function and the second threat action is calculated as 7.6 points. Here, the mapping accuracy may be weighted to the scores for the multiple generative AIs.

Here, in calculating the mapping accuracy score between the second cloud and the second API function, the server 10 has detected the mapping accuracy score of the second generative AI as an outlier, scoring 3 points. In this case, the server 10 may determine that the mapping accuracy between the second cloud and the second API function is low, and modify the mapping information by mapping the second API function to the first threat action.

Also, referring to FIG. 8, in the second table, a mapping accuracy score between the first API function and the first threat action is calculated as 9.5 points, and a mapping accuracy score between the second API function and the second threat action is calculated as 9.2 points. Here, the both mapping accuracies may be determined to be high.

In this case, it may not be appropriate to modify the mapping information for the first and second API functions. Referring to the second table, a similarity score between the first API function and the second API function is shown at the bottom of the table. In the second table, the similarity score between the first API function and the second API function is 6.5 points, which may be determined to be lower than a reference value. In this case, the server 10 may determine that the mapping between the APIs and the threat actions has been appropriately performed and that the matching between the APIs is inappropriate, so the server 10 may not modify the mapping information.

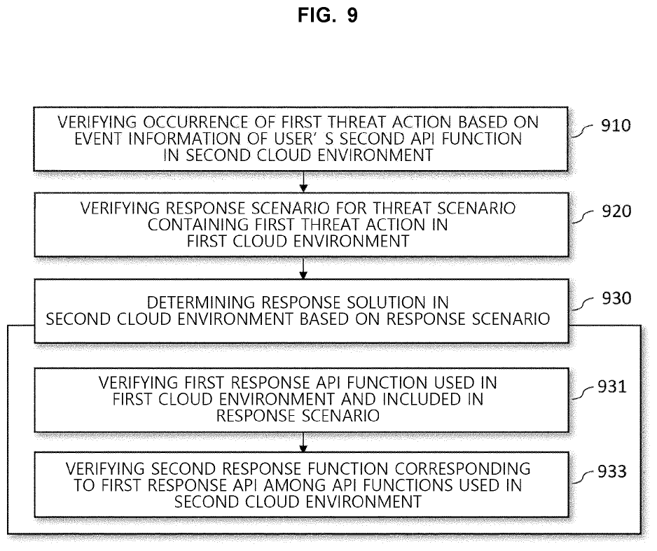

FIG. 9 is a flowchart illustrating a method for determining a response solution based on a response scenario for a threat scenario containing a threat action according to an embodiment of the present disclosure.

At step 910, the server 10 may detect a user's event information of the second API function in the second cloud environment.

Also, the server 10 may verify that the second API function corresponds to the first threat action. Specifically, the server 10 monitors log data, usage patterns, network traffic, system alerts, etc., of the second API function to determine whether the second API function aligns with the first threat action. If any aspect aligns with the first threat action, the server 10 may verify the occurrence of the first threat action.

At step 920, the server 10 verifies a response scenario for a threat scenario containing the first threat action in the first cloud environment.

The server 10 may verify the response scenario for the threat scenario containing the first threat action in the first cloud environment. When the server 10 verifies the response scenario that can be performed in the first cloud environment, the server 10 may perform the response scenario in the second cloud environment based on the response scenario.

Here, a response scenario refers to a series of actions and strategies developed to address a specific threat action. For example, a response scenario may encompass detailed descriptions, use cases, and defense strategies for each attack technique stored in the MITRE ATT&CK, which is an attack technique database.

The server 10 may verify a response scenario for a threat action, which is similar to a threat action that may occur in the second cloud environment, in a cloud environment other than the second cloud environment. For example, the server 10 may review security incident records, threat analysis reports, response protocols, incident logs, etc. in the first cloud environment regarding a threat action occurring in the first cloud environment, which is similar to a threat action occurring in the second cloud environment, or may identify specific measures taken when the first threat action occurred, such as enhancing network traffic monitoring, modifying vulnerable API functions, activating security alert systems, etc.

At step 930, the server 10 determines a response solution in the second cloud environment based on the response scenario.

The server 10 may verify response scenarios for a threat scenario containing the first threat action in the first cloud environment, and determine a response scenario applicable to the second cloud environment among the verified response scenarios as a response solution.

At step 931, the server 10 verifies a first response API function used in the first cloud environment and included in the response scenario.

The server 10 may analyze the nature, purpose, security functions, etc. of API functions used in the response scenario of the first cloud environment. Specifically, it may be a list of API functions used to address a specific threat in the first cloud environment, and detailed information on how each API function has been used to mitigate or address the specific threat.

For example, if a response API function used to address a threat of data leakage in the first cloud environment includes data encryption, enhanced access control, or traffic monitoring, the server 10 may analyze details of these API functions to identify API functions applicable to address any similar security threat in the second cloud environment.

At step 933, the server 10 identifies a second response API function that corresponds to the first response API function among API functions used in the second cloud environment.

The server 10 may identify a second response API function corresponding to the first response API function of the first cloud environment or capable of performing a function similar to the first response API function among the API functions used in the second cloud environment.

The server 10 may analyze the key features and functionalities of the first response API function and discover an API with a similar or identical functionality in the second cloud environment. For example, if there is an API responsible for data encryption in the first cloud environment, the server 10 may find an API with a similar encryption function in the second cloud environment.

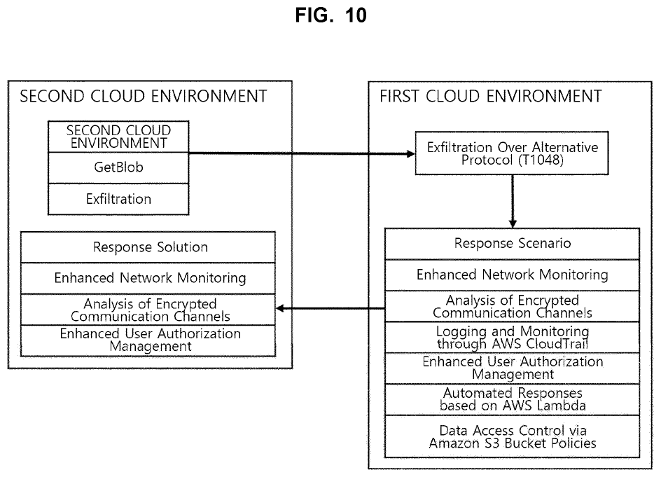

FIG. 10 is a diagram illustrating an example of a process of determining a response solution based on a response scenario for a threat scenario containing a threat action according to an embodiment of the present disclosure.

Referring to FIG. 10, the first cloud environment may be Amazon Web Services

(AWS), and the second cloud environment may be Microsoft Azure.

Referring to FIG. 10, the server 10 may verify that, based on the user's event information from the second API function in the second cloud environment, the second API function corresponds to ‘Exfiltration’ and is mapped to ‘Exfiltration Over Alternative Protocol (T1048)’ which is the first threat action.

The first threat action corresponds to the threat scenario ‘Data Exfiltration Over Alternative Protocol’, and response scenarios to address the corresponding threat scenario includes ‘Enhanced Network Monitoring, “Analysis of Encrypted Communication Channels,’ ‘Logging and Monitoring through AWS CloudTrail,’ ‘Enhanced User Authorization Management,’ ‘Automated Responses based on AWS Lambda,’ and ‘Data Access Control via Amazon S3 Bucket Policies.’

The server 10 may explore threat scenarios related to the first threat action in the second cloud environment and response solutions therefor; however, in some cases, these threat scenarios and response solutions may not be provided in the second cloud environment. Additionally, in some cases, while these threat scenarios and response solutions are provided in the second cloud environment, there might be a need to refer to additional threat scenarios and response solutions in different cloud environments. In such a case, the following method may be performed.

Referring to FIG. 10, the server 10 may verify a response scenario containing a first threat action in the first cloud environment. In addition, the server 10 may identify an entity that can be performed in the second cloud environment from the verified response scenario. Referring to FIG. 10, the server 10 has verified six response scenarios in the first cloud environment, and verified that three of these response scenarios are applicable to the second cloud environment.

The server 10 may perform the three verified response scenarios, identified in the above-described manner, as solutions for addressing the first threat action in the second cloud environment.

According to an embodiment of the present disclosure, it is possible to provide a method for effectively identifying and addressing security threats occurring in various cloud environments.

According to an embodiment of the present disclosure, it is possible to provide a method for improving the efficiency of security management by accurately mapping API functions of cloud services and threat actions.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and variations will be possible from the perspective of those skilled in the art to which the present disclosure pertains. Therefore, the scope of the present disclosure should be determined by the scope of the appended claims, and equivalents thereof.

What is claimed is:

1. A method for mapping API functions to threat actions by a server in multiple cloud environments, the method comprising:
a) mapping a first API function used in a first cloud environment provided by a first cloud server to a first threat action included in an attack technique database where a plurality of threats classified into multiple types is stored;
b) generating feature information of the first API function based on descriptive information for the first API function provided by the first cloud server;
c) based on the feature information of the first API function, identifying a second API function matching the first API function among at least one API function used in a second cloud environment provided by a second cloud server; and
d) mapping the second API function to the first threat action.

2. The method of claim 1, wherein step b) comprises:
transmitting a first request prompt to a generative artificial intelligence server, asking for summary information of a first API which encapsulates the descriptive information for the first API function;
receiving the summary information of the first API from the generative artificial intelligence server in response to the first request prompt; and
generating the feature information of the first API based on the summary information of the first API.

3. The method of claim 2, wherein:
step b) further comprises identifying a service performed in the first cloud environment when the first API function is executed, and
the feature information is also based on information on the service.

4. The method of claim 1, wherein step c) comprises:
generating feature information of the second API function based on descriptive information for the second API function provided by the second cloud server;
requesting similarity information between the feature information of the first API function and the feature information of the second API function from the generative artificial intelligence server, and receiving the similarity information from the generative artificial intelligence server;
based on the similarity information, determining the first API function and the second API function as similar API functions; and
identifying the second API function as an API function aligning with the first API function.

5. The method of claim 4, wherein:
the generative artificial intelligence server is provided as a plurality of generative artificial intelligence servers, and the similarity information comprises a plurality of pieces of similarity information generated from the plurality of generative artificial intelligence servers, and
in determining as the similar API functions, the server compares the plurality of pieces of similarity information to determine whether the first API function and the second API function are similar.

6. The method of claim 5, wherein each of the plurality of pieces of similarity information is assigned a predetermined weight based on a corresponding generative artificial intelligence server.

7. The method of claim 4, wherein the generating of the feature information of the first and second API functions comprises:
transmitting first and second request prompts to the generative artificial intelligence server, asking for summary information of first and second APIs, which encapsulates the descriptive information for the first and second API functions;
receiving the summary information of the first and second APIs in response to the first and second request prompts from the generative artificial intelligence server; and
based on the summary information of the first and second APIs, generating feature information of the first and second API functions.

8. The method of claim 7, wherein the first and second request prompts comprise a request to generate the summary information for the first and second APIs based on same content items.

9. The method of claim 4, wherein:
the identifying of the second API function further comprises identifying a terminology database in which terms used in the first and second cloud environments are matched, and
in receiving the similarity information, the server provides the generative artificial intelligence server with information on the terminology database and requests generation of the similarity information based on the terminology database.

10. The method of claim 1, further comprising:
verifying occurrence of the first threat action based on a user's event information of the second API function in the second cloud environment;
verifying a response scenario for a threat scenario containing the first threat action in the first cloud environment; and
based on the response scenario, determining a response solution in the second cloud environment.

11. The method of claim 10, wherein the determining of the response solution comprises:
verifying a first response API function used in the first cloud environment and included in the response scenario; and
verifying a second response API function corresponding to the first response API function among the at least one API function used in the second cloud environment.

12. The method of claim 1,
wherein the following steps are performed between step (c) and step (d):
verifying information where the second API function is mapped to a second threat action included in the attack technique database, wherein the first and second threat actions are different from each other; and
comparing mapping accuracy between first mapping information, where the first API function and the first threat action are mapped to each other, and second mapping information, where the second API function and the second threat action are mapped to each other,
wherein when a mapping accuracy of the first mapping information is higher than a mapping accuracy of the second mapping information, step d) is performed,
wherein when the mapping accuracy of the second mapping information is higher than the mapping accuracy of the first mapping information, step d) is not performed and instead the first API function is mapped to the second threat action.

13. The method of claim 12, wherein:
the first mapping information comprises a plurality of pieces of mapping index information for the first API function and the first threat action, received from a plurality of generative artificial intelligence servers,
the second mapping information comprises a plurality of pieces of mapping index information for the second API function and the second threat action, received from a plurality of generative artificial intelligence servers, and
the server compares the mapping accuracy based on outlier information of the plurality of pieces of mapping index information included in each of the first and second mapping information.

14. The method of claim 1, wherein the attack technique database comprises information on types of attack techniques, descriptive information for the attack techniques, and information on detailed techniques included in the attack techniques, wherein the type is a higher-level concept comprising at least one of the attack techniques, and each of the attack techniques is a higher-level concept comprising at least one of the detailed techniques.
